(19) United States
(12) Patent Application Publication
(10) Pub. No.: US 2008/0240308 A1
(43) Pub. Date: Oct. 2, 2008

(54) APPARATUS AND METHOD FOR ESTIMATING CHANNEL USING SLIDING WINDOWS IN A BROADBAND WIRELESS COMMUNICATION SYSTEM

(75) Inventors: Ik-Beom LEE, Yongin-si (KR); Ha-Young YANG, Yongin-si (KR); Jae-Ho JEON, Seongnam-si (KR); Seung-Joo MAENG, Seongnam-si (KR); Myung-Kwang BYUN, Suwon-si (KR)

Correspondence Address: Jefferson IP Law, LLP, 1730 M Street, NW, Suite 807, Washington, DC, 20036, US

(73) Assignee: SAMSUNG ELECTRONICS CO. LTD., Suwon-si (KR)

(21) Appl. No.: 12/056,540

(22) Filed: Mar. 27, 2008

(30) Foreign Application Priority Data
Mar. 27, 2007 (KR) 2007-0029554

(51) Int. Cl. H04L 27/06

(52) U.S. Cl. 375/343

(57) ABSTRACT

An apparatus and a method for estimating a channel using sliding windows in a broadband wireless communication system are provided. The apparatus includes an estimator, a first calculator, a second calculator, and a third calculator. The estimator estimates a speed of travel. The first calculator calculates a time correlation values using the estimated speed. The second calculator calculates weight factors using the time correlation values. The third calculator calculates a channel estimation value by multiplying corresponding pilot symbols by the weight factors and equalizing the pilot symbols.

### PRIORITY

This application claims the benefit under 35 U.S.C. §119(a) of a Korean patent application filed in the Korean Intellectual Property Office on Mar. 27, 2007 and assigned Serial No. 2007-29554, the entire disclosure of which is hereby incorporated by reference.

### BACKGROUND OF THE INVENTION

1. Field of the Invention

The present invention relates to a broadband wireless communication system. More particularly, the present invention relates to an apparatus and method for estimating a channel in a broadband wireless communication system.

2. Description of the Related Art

In 4^{th}-Generation (4G) communication systems, an emphasis has been placed on providing users with services having a variety of Qualities of Service (QoS) using a transmission speed of about 100 Mbps. In particular, in conventional 4G communication systems, research is being conducted to support high-speed services by ensuring both mobility and QoS to Broadband Wireless Access (BWA) communication systems such as Wireless Local Area Network (WLAN) communication systems and Wireless Metropolitan Area Network (WMAN) communication systems.

An exemplary 4G communication system is an Institute of Electrical and Electronics Engineers (IEEE) 802.16 communication system. The IEEE 802.16 communication system applies an Orthogonal Frequency Division Multiplexing (OFDM)/Orthogonal Frequency Division Multiple Access (OFDMA) scheme in order to provide a broadband transmission network to a physical channel of the wireless communication system.

The OFDM communication system transmits/receives an OFDM symbol in Time Division Duplex (TDD) scheme. The OFDM symbol is created by mapping a plurality of complex symbols to a frequency axis and performing an Inverse Fast Fourier Transform (IFFT) operation. That is, the OFDM communication system maps a data symbol and a signal for a specific purpose to a physical frequency resource called a subcarrier, for transmission/reception.

Because a broadband wireless communication system has to transmit/receive high-quality data at high speed, the system requires information on a radio channel to efficiently use a limited radio resource. In other words, the system has to select an optimal technique with reference to radio channel state information and interference information in selecting techniques related to signal detection such as a modulation/demodulation and decoding technique, a multi-channel reception technique, etc. That is, system performance is dependent on the accuracy of the radio channel information.

An example of a signal for acquiring the radio channel information is a pilot symbol. In general, the pilot symbol is equally distributed to a frequency domain and a time domain within a subchannel and is positioned between data symbols. That is, a receiving end can obtain radio channel information for detecting data symbols, by estimating a channel using pilot symbols that are received mixed with the data symbols. Because the system performance is dependent on the accuracy of the channel estimation as mentioned above, there is needed an apparatus and method for acquiring a more accurate channel estimation value.

### SUMMARY OF THE INVENTION

An aspect of the present invention is to address at least the above-mentioned problems and/or disadvantages and to provide at least the advantages described below. Accordingly, an aspect of the present invention is to provide an apparatus and method for improving the accuracy of channel estimation in a broadband wireless communication system.

Another aspect of the present invention is to provide an apparatus and method for estimating a channel using sliding windows in a broadband wireless communication system.

A further aspect of the present invention is to provide an apparatus and method for calculating a weight, for sliding window channel estimation in a broadband wireless communication system.

The above aspects are addressed by providing an apparatus and method for estimating a channel in a broadband wireless communication system.

According to one aspect of the present invention, a receiving end apparatus in a broadband wireless communication system is provided. The apparatus includes an estimator, a first calculator, a second calculator, and a third calculator. The estimator estimates a speed of travel. The first calculator calculates a time correlation value between each pilot symbol included in one or more sliding windows and a pilot symbol of a channel to be estimated, using the estimated speed. The second calculator calculates a weight factor for each of the respective pilot symbols included in the one or more sliding windows using the time correlation value. The third calculator calculates a channel estimation value by multiplying each of the pilot symbols included in the one or more sliding windows by the corresponding weight factor and for equalizing the pilot symbols that have been multiplied together with the weight factors.

According to another aspect of the present invention, a method for channel estimation in a receiving end of a broadband wireless communication system is provided. The method includes estimating a speed of travel, calculating a time correlation value between each pilot symbol included in one or more sliding windows and a pilot symbol of a channel to be estimated using the estimated speed, calculating a weight factor for each of the respective pilot symbols included in the one or more sliding windows using the time correlation value, and calculating a channel estimation value by multiplying each of the pilot symbols included in the one or more sliding windows by the corresponding weight factor and by equalizing the pilot symbols that have been multiplied together with the weight factors.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will become more apparent from the following description taken in conjunction with the accompanying drawings, in which:

FIG. 1 is a diagram illustrating a first subchannel structure in a broadband wireless communication system according to an exemplary embodiment of the present invention;

FIG. 2 is a diagram illustrating a second subchannel structure in a broadband wireless communication system according to an exemplary embodiment of the present invention;

FIG. 3 is a diagram illustrating symbol use for channel estimation in the subchannel of FIG. 1, according to an exemplary embodiment of the present invention;

FIG. 4 is a diagram illustrating symbol use for channel estimation in the subchannel of FIG. 2, according to an exemplary embodiment of the present invention;

FIG. 5 is a block diagram illustrating a construction of a receiving end in a broadband wireless communication system according to an exemplary embodiment of the present invention;

FIG. 6 is a block diagram illustrating a construction of a channel estimator in a broadband wireless communication system according to an exemplary embodiment of the present invention; and

FIG. 7 is a diagram illustrating a process of channel estimation in a receiving end of a broadband wireless communication system according to an exemplary embodiment of the present invention.

Throughout the drawings, it should be noted that like reference numbers are used to depict the same or similar elements, features and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

Exemplary embodiments of the present invention provide a sliding window channel estimation technology that applies a weight based on a pilot symbol in a broadband wireless communication system. While an Orthogonal Frequency Division Multiplexing (OFDM) wireless communication system is described in the exemplary embodiments of the present invention, the present invention is equally applicable to any wireless communication system using multiple carriers.

A subchannel structure taken into consideration in the exemplary embodiments of the present invention and a channel estimation scheme based on the subchannel structure are described.

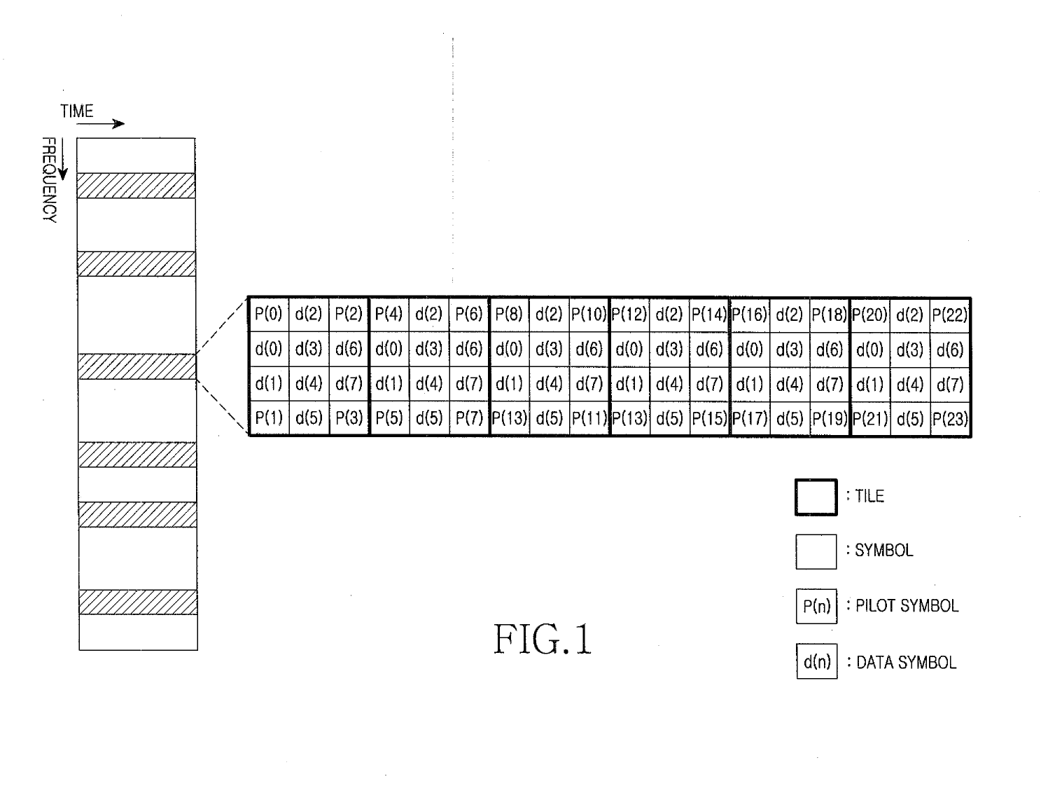

FIG. 1 illustrates a subchannel structure, wherein each subchannel comprises tiles allocated with resources. A tile is comprised of 4×3 symbols taken on a frequency axis and a time axis. The tile is a unit of resources including 4 pilot symbols and 8 data symbols. FIG. 1 illustrates specific time allocation domains called slots. Each of the slots comprise a plurality of subchannels. The subchannels each include a plurality of tiles. FIG. 1 illustrates that 6 tiles constitute one subchannel. Adjacent time-axis tiles can be either allocated to the same Mobile Station (MS) or can be allocated to different MSs. When adjacent time-axis tiles are allocated to the same MS, it is called a ‘subchannel-circulation disabled state’. When adjacent time-axis tiles are allocated to different MSs, it is called a ‘subchannel-circulation enabled state’.

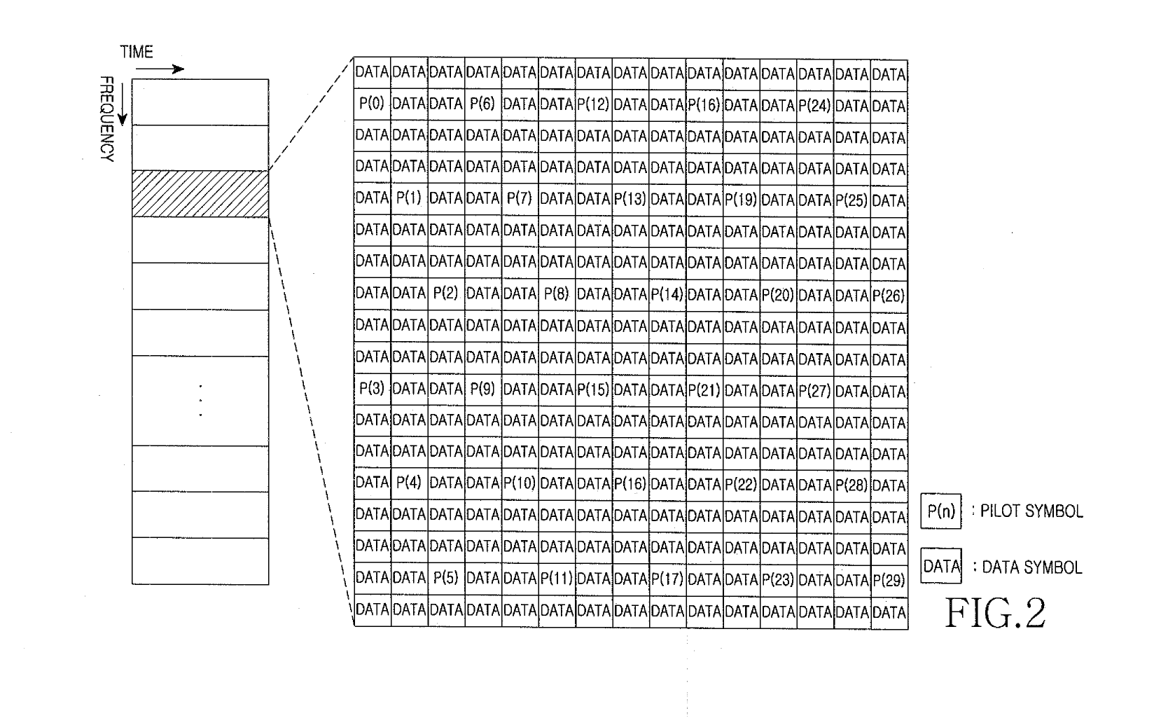

FIG. 2 illustrates a subchannel structure wherein each subchannel comprises a frequency band allocated with resources. As illustrated in FIG. 2, each subchannel includes a continuous frequency band of a constant size. Adjacent time-axis symbols are included in the same subchannel. That is, adjacent time-axis resources are used by the same transmitting end. Each subchannel includes a plurality of data symbols and a plurality of pilot symbols.

As illustrated in FIGS. 1 and 2, each subchannel includes data symbols and pilot symbols. The data symbols and pilot symbols transmitted by a transmitting end may be distorted while they are being communicated through a radio channel and being received by a receiving end. Thus, the receiving end estimates a channel state by using at least one pilot symbol, compensates for any channel distortion using a channel value that represents the estimated channel state, and obtains a soft decision value. For instance, in the case of uplink communication over the subchannel of the structure of FIG. 1, a Base Station (BS) estimates and compensates a frequency offset and a timing offset using at least one pilot symbol and estimates and compensates a channel for a phase shift and a change in magnitude. The BS performs noise estimation using the at least one pilot symbol to obtain a Signal to Noise Ratio (SNR), estimates a channel state, and then calculates a soft decision value using a channel estimation value.

Because the channel estimation value is used for calculating the soft decision value as mentioned above, the accuracy of the channel estimation value has an influence on system reception performance. In the case of the subchannel of FIG. 1, four pilot symbols per tile are transmitted for channel estimation. In a subchannel circulation enabled state, because one transmitting end makes use of tiles of a frequency-axis position differently for every slot, channel estimation for each tile should be implemented using only pilot symbols included in each tile. In a subchannel circulation disabled state, because one transmitting end continuously makes use of tiles of the same frequency-axis position, channel estimation can be implemented using a plurality of pilot symbols included within adjacent time-axis tiles. In the case of the subchannel of FIG. 2, channel estimation can be performed using a plurality of adjacent time-axis pilot symbols in the same manner as in the subchannel circulation disabled state of the structure of FIG. 1.

A description of a scheme of estimating a channel using a plurality of adjacent time-axis pilot symbols in the subchannels of the structures of FIGS. 1 and 2 where subchannel circulation is disabled according to an exemplary embodiment of the present invention is presented below.

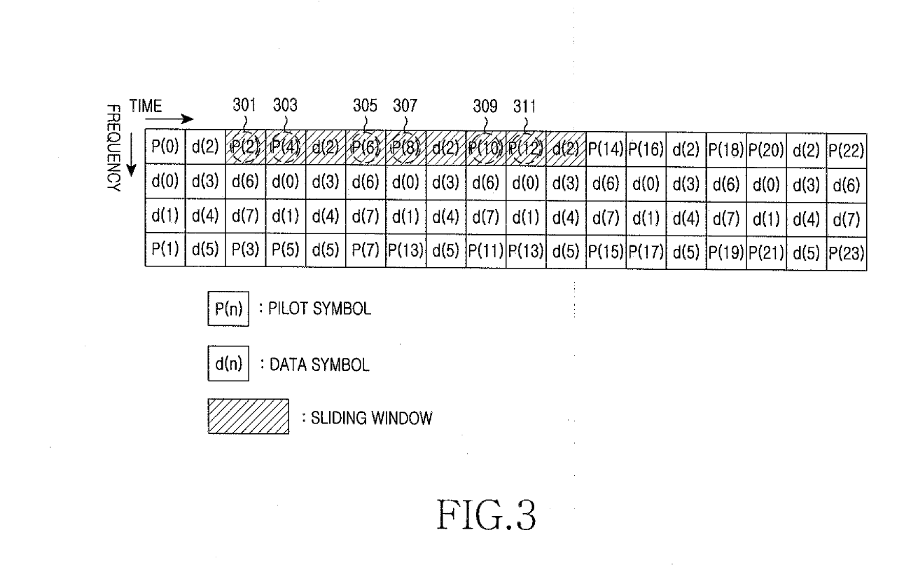

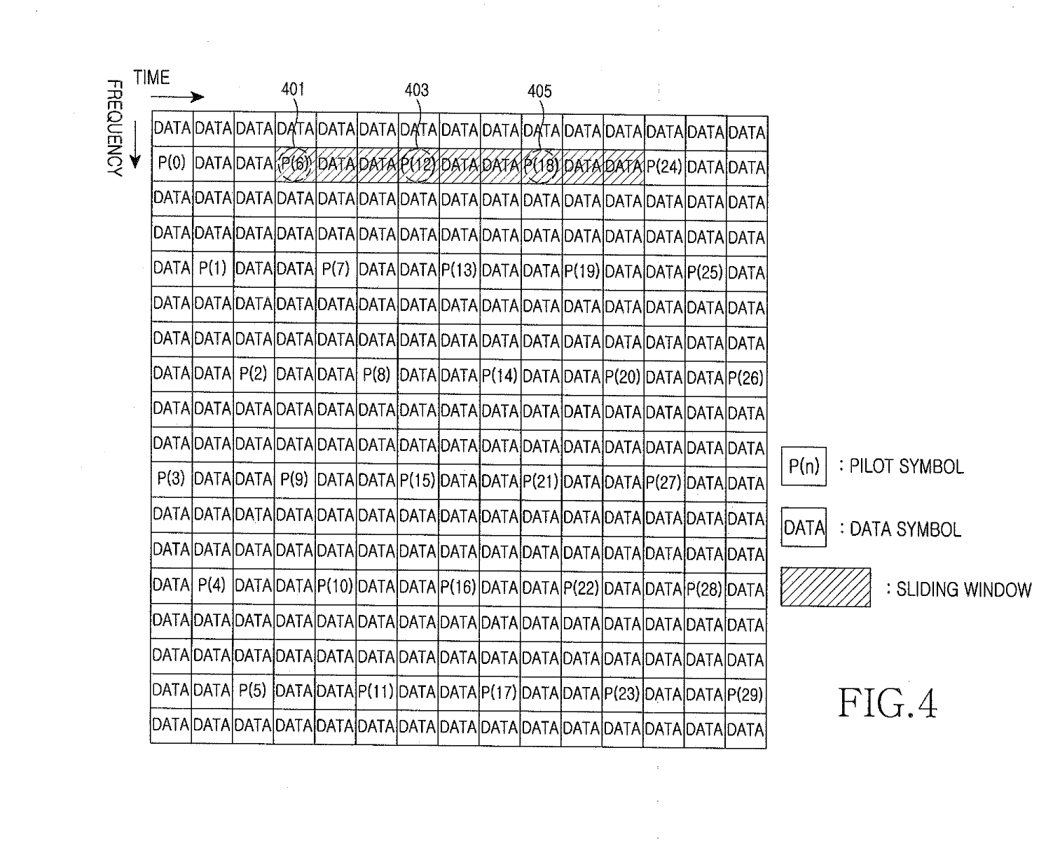

As shown in FIGS. 3 and 4, channel estimation using the plurality of pilot symbols is performed using sliding windows. FIG. 3 shows a scheme in which sliding windows are taken that center on a pilot symbol ‘P(8)’ 307 to calculate a channel estimation value for the pilot symbol ‘P(8)’ 307. FIG. 4 shows a scheme in which sliding windows are taken that center on a pilot symbol ‘P(12)’ 403 to calculate a channel estimation value for the pilot symbol ‘P(12)’ 403.

The simplest scheme of channel estimation using sliding windows is to equalize pilot symbols included within windows. That is, in FIG. 3, a channel estimation value for the pilot symbol ‘P(8)’ 307 is decided as a value equalizing pilot symbols ‘P(2)’ 301, ‘P(4)’ 303, ‘P(6)’ 305, ‘P(8)’ 307, ‘P(10)’ 309, and ‘P(12)’ 311. In FIG. 4, a channel estimation value for the pilot symbol ‘P(12)’ 403 is decided as a value equalizing pilot symbols ‘P(6)’ 401, ‘P(12)’ 403, and ‘P(18)’ 405. The sliding-window channel estimation value using the equalization can be expressed in Equation 1 below:

$$\hat{h} = \frac{1}{N} {\sum }_{k = 1}^{N} {x}_{k}^{*} \times ( {hx}_{k} + {n}_{k} ) = h + \frac{1}{N} {\sum }_{k = 1}^{N} {n}_{k} \approx h \qquad ( 1 )$$

where,
ĥ: channel estimation value,
N: number of pilot symbols included in the sliding windows,
xₖ: a transmitted value of the k^{th} pilot symbol included in the sliding window,
h: channel factor,
nₖ: noise corresponding to the k^{th} pilot symbol, and

$$\frac{1}{N} {\sum }_{k = 1}^{N} {n}_{k} \text{:}$$

estimation error.

Here, assuming that the noise (nₖ) follows Gaussian distribution, the estimation error can be expressed in Equation 2 below:

$$\frac{1}{N} {\sum }_{k = 1}^{N} {n}_{k} = η ( 0 , \frac{1}{N} {σ}_{k}^{2} ) \qquad ( 2 )$$

where,
N: number of pilot symbols included in the sliding windows,
nₖ: noise corresponding to k^{th} pilot signal,
η(x,y): symbol representing that mean of normal distribution is ‘x’ and variance is ‘y’, and
σₖ²: variance of noise.
In Equation 2, the estimation error decreases as the number of the pilot symbols included within the sliding windows increases.

The sliding window channel estimation using the equalization is suitable in an environment where there is no channel change during a sliding window interval. However, the sliding window channel estimation using the equalization does not provide an optimal channel estimation value because a radio channel varies over time. The following is a scheme of a sliding window channel estimation that minimizes a Mean Square Error (MSE) by taking into consideration the time-varying characteristic of the radio channel.

The following description is based on the assumption that ‘2P+1’ denotes a size of a sliding window, ‘hₖ’ denotes a channel intended for estimation, and ‘nₖ’ denotes a pilot symbol being communicated through a channel intended for estimation. A received signal within the sliding window can be expressed in Equation 3 below:

y=Hx+n (3)
where,
y: received signal vector of (2P+1) size,
H: channel factor matrix having a form of a diagonal matrix of (2P+1)×(2P+1) size,
x: transmitted signal vector of (2P+1) size, and
n: noise vector.

Here, an MSE of a channel estimation value is expressed in Equation 4 below:

ε=E[∥w^{T} y−hₖ∥²] (4)
where,
ε: MSE of channel estimation value,
E[•]: mean operator
w: weight factor for minimizing MSE,
y: received signal vector, and
hₖ: channel factor intended for estimation.

Here, the weight factor (w) is calculated by a Wiener Solution in Equation 5 below:

w=R_{yy}⁻¹P_{yh} (5)
where,
w: weight factor,
R_{yy}: covariance matrix of received signal, and
P_{yh}: cross correlation vector between received signal and channel factor.

Here, the covariance matrix (R_{yy}) of the received signal and the cross correlation vector (P_{yh}) between the received signal and the channel factor are defined in Equation 6 below:

R_{yy}=E[yy^{H}]

P_{yh}=E[yhₖ* ] (6)
where,
R_{yy}: covariance matrix of the received signal,
E[•]: mean operator
y: received signal vector,
P_{yh}: cross correlation vector between the received signal and the channel factor, and
hₖ: channel factor intended for estimation.

First, a time correlation value has to be calculated in order to calculate the covariance matrix (R_{yy}) of the received signal and the cross correlation vector (P_{yh}) between the received signal and the channel factor. The time correlation value is calculated in Equation 7 below:

$$ρ ( {τ}_{p} ) = {J}_{0} ( 2 π {f}_{c} \frac{v}{c} {τ}_{p} ) \qquad ( 7 )$$

where,
ρ(•): time correlation value operator,
J₀(•): 0^{th} order Bessel function of the first kind,
f_{c}: doppler frequency depending on speed,
ν: speed, and
τₚ: time interval seeking time correlation value.

If the covariance matrix (R_{yy}) of the received signal is calculated using the time correlation value, it is expressed in Equation 8 below:

$${R}_{yy} = [ \begin{matrix}{R}_{k - P , k - P} & ⋯ & {R}_{k - P , k} & ⋯ & {R}_{k - P , K + P} \\ ⋮ & ⋰ & ⋮ & ⋰ & ⋮ \\ {R}_{k , k - P} & ⋯ & {R}_{k , k} & ⋯ & {R}_{k , k + P} \\ ⋮ & ⋰ & ⋮ & ⋰ & ⋮ \\ {R}_{k + P , k - P} & ⋯ & {R}_{k + P , k} & ⋯ & {R}_{k + P , k + P}\end{matrix} ] \\ {R}_{m , n} = ρ ( {τ}_{m - n} ) {\vert h \vert}^{2} + {σ}^{2} \qquad ( 8 )$$

where,
R_{yy}: covariance matrix of the received signal,
R_{m,n}: element corresponding to ‘m’ row and ‘n’ column of R_{yy},
ρ(•): time correlation value operator,
τₘ₋ₙ: time interval seeking time correlation value,
h: channel matrix, and
σ²: variance of noise.

Here, the noise variance is obtained from an SNR. That is, the covariance matrix (R_{yy}) of the received signal is calculated from the SNR and the time correlation value.

If the cross correlation vector (P_{yh}) between the received signal and the channel factor is calculated using the time correlation value, each element of the cross correlation vector (P_{yh}) is expressed in Equation 9 below:

P_{yh}=[P_{k-P,k} . . . P_{k,k} . . . P_{k+P,k}]^{T}

P_{m,k}=ρ(τₘ₋ₖ)|h|² (9)
where,
P_{yh}: cross correlation vector between the received signal and the channel factor,
P_{m,k}: element corresponding to ‘k’ row and ‘m’ column of P_{yh},
ρ(•): time correlation value operator,
τₘ₋ₖ: time interval seeking time correlation value, and
h: channel matrix.

Here, the cross correlation vector (P_{yh}) between the received signal and the channel factor is calculated from a time correlation value.

In Equations 5 to 9, a receiving end calculates a weight factor (w), multiplies each of the pilot symbols included in sliding windows by the weight factor (w), and calculates a channel estimation value. For example, if a sliding window is positioned as shown in FIG. 3, a receiving end substitutes a time interval between a pilot symbol ‘P(8)’ 307 and each of remaining pilot symbols and calculates a time correlation value in Equation 7, in order to calculate a channel estimation value for the pilot symbol ‘P(8)’ 307. Then, the receiving end calculates a covariance matrix (R_{yy}) of a received signal and a cross correlation vector (P_{yh}) between the received signal and a channel vector in Equations 8 and 9, respectively. Then, the receiving end calculates weight factors ‘w[1]’, ‘w[2]’, ‘w[3]’, ‘w[4]’, ‘w[5]’, and ‘w[6]’ in Equation 5 and performs an optimal sliding window channel estimation by multiplying each pilot symbol together with a corresponding weight factor. As in FIG. 3 and FIG. 4, a receiving end calculates a weight factor and performs an optimal sliding window channel estimation by multiplying each of the pilot symbols ‘P(6)’ 401, ‘P(12)’ 403, and ‘P(18)’ 405 together with a corresponding weight factor in Equations 5 to 9.

A construction and operational process of a receiving end for performing sliding window channel estimation using the above schemes are described in detail below with reference to the accompanying drawings.

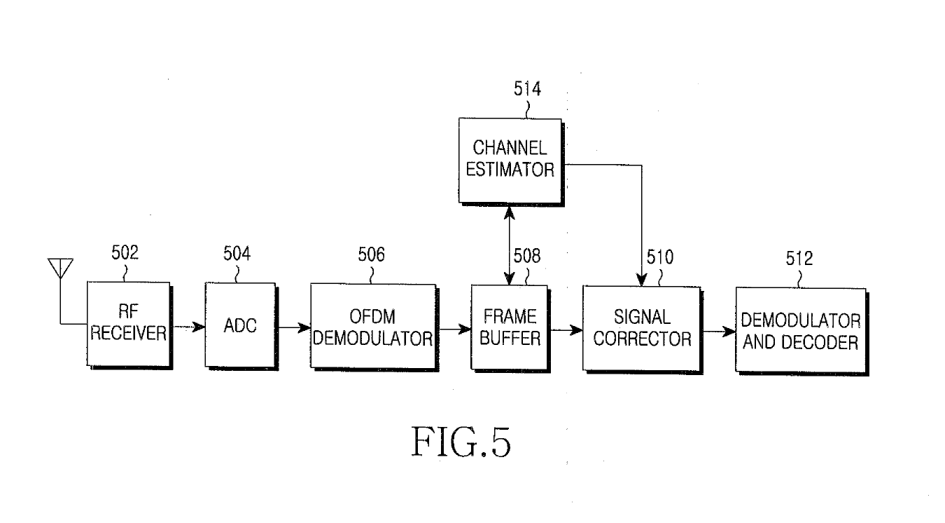

FIG. 5 is a block diagram illustrating a construction of a receiving end in a broadband wireless communication system according to an exemplary embodiment of the present invention.

As shown in FIG. 5, the receiving end includes a Radio Frequency (RF) receiver 502, an Analog to Digital Converter (ADC) 504, an OFDM demodulator 506, a frame buffer 508, a symbol corrector 510, a demodulator and decoder 512, and a channel estimator 514.

The RF receiver 502 converts an RF signal received through an antenna into a baseband signal. The ADC 504 samples and quantizes an analog signal provided from the RF receiver 502 and converts the analog signal into a digital signal. The OFDM demodulator 506 restores at least one signal of at least one subcarrier from a time-domain OFDM symbol provided from the ADC 504, through a Fast Fourier Transform (FFT) operation. The frame buffer 508 stores one or more of the at least one signals of the at least one subcarrier provided from the OFDM demodulator 506, in a frame unit.

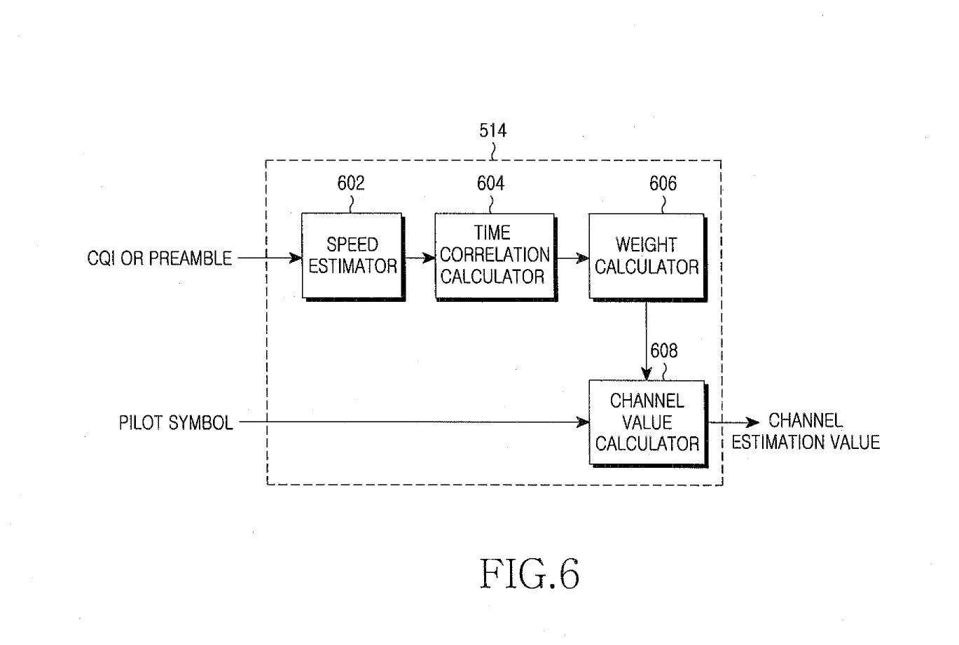

The symbol corrector 510 corrects a distortion of a data symbol, which is provided from the frame buffer 508, using a channel estimation value provided from the channel estimator 514. The demodulator and decoder 512 demodulates and decodes a complex symbol provided from the symbol corrector 510 in compliance with a corresponding scheme and converts the complex symbol into an information bit stream. The channel estimator 514 performs channel estimation using sliding windows. In particular, the channel estimator 514 grants a weight to each of the pilot symbols included in the sliding windows and calculates a channel estimation value according to an exemplary embodiment of the present invention. Construction of the channel estimator 514 is described in detail below with reference to FIG. 6.

FIG. 6 is a block diagram illustrating a construction of a channel estimator in a broadband wireless communication system according to an exemplary embodiment of the present invention.

As shown in FIG. 6, the channel estimator 514 includes a speed estimator 602, a time correlation calculator 604, a weight calculator 606, and a channel value calculator 608.

The speed estimator 602 estimates a speed of travel of a receiving end or a transmitting end. If the receiving end is an MS, the speed estimator 602 estimates its own speed using a preamble that is received from a BS. Alternatively, if the receiving end is a BS, the speed estimator 602 estimates a speed of an MS (the transmitting end) using Channel Quality Information (CQI) fed back over a CQI feedback channel.

The time correlation calculator 604 calculates a time correlation value between each of the pilot symbols included in sliding windows and a pilot symbol of a channel intended for estimation. As in Equation 7, the time correlation value is calculated using speed information estimated by the speed estimator 602. There are as many time correlation values calculated as there are pilot symbols included in the sliding windows.

The weight calculator 606 calculates a weight factor to be multiplied together with each of the pilot symbols included in sliding windows. In particular, the weight calculator 606 calculates weight factors, by calculating a covariance matrix of a received signal and a cross correlation vector between the received signal and a channel factor. The calculation is performed by using a time correlation value for each pilot symbol calculated by the time correlation calculator 604. An inverse matrix of the covariance matrix of the received signal is then multiplied together with the cross correlation vector between the received signal and the channel factor. For instance, the weight calculator 606 calculates the covariance matrix of the received signal in Equation 8 and calculates the cross correlation vector between the received signal and the channel factor in Equation 9. Then, the weight calculator 606 calculates the weight factors in Equation 5.

The channel value calculator 608 calculates a channel estimation value using the weight factors calculated by the weight calculator 604. That is, the channel value calculator 608 calculates a channel estimation value by multiplying each of the pilot symbols included in sliding windows by a corresponding weight factor and then equalizing the pilot symbols multiplied together with the weight factors.

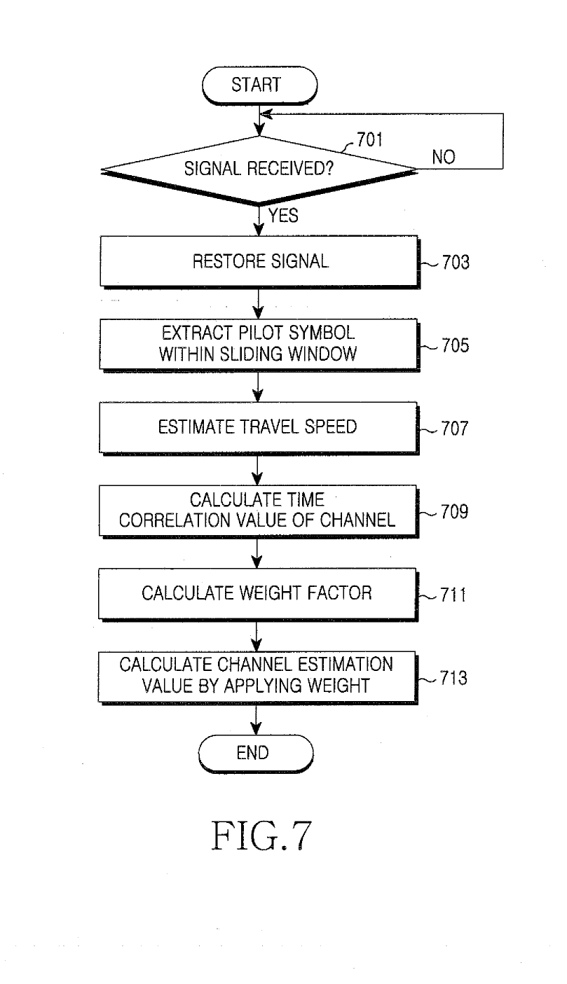

FIG. 7 is a diagram illustrating a process of channel estimation in a receiving end of a broadband wireless communication system according to an exemplary embodiment of the present invention.

Referring to FIG. 7, in step 701, the receiving end identifies whether it receives a signal including one or more data symbols and one or more pilot symbols from a transmitting end.

If the signal is received, the receiving end restores at least one signal of at least one subcarrier in step 703. In other words, the receiving end processes the received signal by FFT operation, thereby restoring at least one signal of at least one subcarrier.

Then, the receiving end positions sliding windows and extracts pilot symbols within the sliding windows in step 705. That is, the receiving end extracts a pilot symbol corresponding to a channel intended for estimation and at least one pilot symbol positioned at the same frequency axis as the pilot symbol.

Next, the receiving end estimates a speed of travel in step 707. If the receiving end is an MS, the receiving end estimates its own speed using a preamble signal received from a BS. Alternatively, if the receiving end is a BS, the receiving end estimates a speed of an MS using CQI information received over a CQI feedback channel.

After the speed is estimated, in step 709, the receiving end calculates a time correlation value of a channel. In Equation 7, the time correlation values are calculated using the speed information. There are as many time correlation values calculated that there are pilot symbols included in the sliding windows.

After the time correlation values are calculated, the receiving end calculates a weight factor to be multiplied together with each of the pilot symbols included in sliding windows in step 711. In particular, the receiving end calculates weight factors by calculating a covariance matrix of a received signal and a cross correlation vector between the received signal and a channel factor using the time correlation value of each pilot symbol. An inverse matrix of the covariance matrix of the received signal is then multiplied together with the cross correlation vector between the received signal and the channel factor. For instance, the receiving end calculates the covariance matrix of the received signal in Equation 8 and calculates the cross correlation vector between the received signal and the channel factor in Equation 9. Then, the receiving end calculates the weight factors in Equation 5.

After the weight factors are calculated, in step 713, the receiving end calculates a channel estimation value by multiplying each of the pilot symbols included in sliding windows by a corresponding weight factor and then equalizing the pilot symbols multiplied together with the weight factors.

As described above, a system can acquire an optimal channel estimation value for a time-varying radio channel by performing a sliding window channel estimation by applying a weight in a broadband wireless communication system.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A receiving end apparatus in a wireless communication system, the apparatus comprising:
an estimator for estimating a speed of travel of the receiving end apparatus or a transmitting end apparatus;
a first calculator for calculating a time correlation value between each pilot symbol included in one or more sliding windows and a pilot symbol of a channel to be estimated, using the estimated speed;
a second calculator for calculating a weight factor for each of the respective pilot symbols included in the one or more sliding windows using the time correlation value; and
a third calculator for calculating a channel estimation value by multiplying each of the pilot symbols included in the one or more sliding windows by the corresponding weight factor and for equalizing the pilot symbols that have been multiplied together with the weight factors.

2. The apparatus of claim 1, wherein, if the receiving end apparatus is a Mobile Station (MS), the estimator estimates the speed of travel of the receiving end apparatus using a preamble signal received from a Base Station (BS).

3. The apparatus of claim 1, wherein, if the receiving end apparatus is a Base Station (BS), the estimator estimates the speed of travel of the transmitting end apparatus, a Mobile Station (MS), using Channel Quality Information (CQI) received over a CQI feedback channel from the Mobile Station (MS).

4. The apparatus of claim 1, wherein the first calculator calculates the time correlation value using an equation:
$$ρ ( {τ}_{p} ) = {J}_{0} ( 2 π {f}_{c} \frac{v}{c} {τ}_{p} )$$
where,
ρ(•): time correlation value operator,
J₀(•): 0^{th} order Bessel function of first kind,
f_{c}: Doppler frequency depending on speed,
ν: speed, and
τₚ: time interval seeking time correlation value.

5. The apparatus of claim 1, wherein the second calculator calculates the weight factors by calculating a covariance matrix of a received signal and a cross correlation vector between the received signal and a channel factor and multiplies an inverse matrix of the covariance matrix together with the cross correlation vector.

6. The apparatus of claim 5, wherein the second calculator calculates the covariance matrix using equations:
$${R}_{yy} = [ \begin{matrix}{R}_{k - P , k - P} & ⋯ & {R}_{k - P , k} & ⋯ & {R}_{k - P , K + P} \\ ⋮ & ⋰ & ⋮ & ⋰ & ⋮ \\ {R}_{k , k - P} & ⋯ & {R}_{k , k} & ⋯ & {R}_{k , k + P} \\ ⋮ & ⋰ & ⋮ & ⋰ & ⋮ \\ {R}_{k + P , k - P} & ⋯ & {R}_{k + P , k} & ⋯ & {R}_{k + P , k + P}\end{matrix} ]$$
$${R}_{m , n} = ρ ( {τ}_{m - n} ) {\vert h \vert}^{2} + {σ}^{2}$$
where,
R_{yy}: covariance matrix of received signal,
R_{m,n}: element corresponding to ‘m’ row and ‘n’ column of R_{yy},
ρ(•): time correlation value operator,
τₘ₋ₙ: time interval seeking time correlation value,
h: channel matrix, and
σ²: variance of noise.

7. The apparatus of claim 5, wherein the second calculator calculates the cross correlation vector using equations:
P_{yh}=[P_{k-P,k} . . . P_{k,k} . . . P_{k+P,k}]^{T}
P_{m,k}=ρ(τₘ₋ₖ)|h|²
where,
P_{yh}: cross correlation vector between received signal and channel factor,
P_{m,k}: element corresponding to ‘k’ row and ‘m’ column of P_{yh},
ρ(•): time correlation value operator,
τₘ₋ₖ: time interval seeking time correlation value, and
h: channel matrix.

8. The apparatus of claim 1, further comprising:
a receiver for down converting a Radio Frequency (RF) signal received through an antenna into a baseband signal;
a converter for converting an analog signal from the receiver into a digital signal; and
a demodulator for restoring at least one signal of at least one subcarrier from an Orthogonal Frequency Division Multiplexing (OFDM) symbol from the converter, through Fast Fourier Transform (FFT) operation.

9. The apparatus of claim 1, further comprising:
a corrector for correcting a distortion of a data symbol using the channel estimation value.

10. A method for channel estimation in a receiving end of a wireless communication system, the method comprising:
estimating a speed of travel travel of the receiving end apparatus or a transmitting end apparatus;
calculating a time correlation value between each pilot symbol included in one or more sliding windows and a pilot symbol of a channel to be estimated using the estimated speed;
calculating a weight factor for each of the respective pilot symbols included in the one or more sliding windows using the time correlation value; and
calculating a channel estimation value by multiplying each of the pilot symbols included in the one or more sliding windows by the corresponding weight factor and by equalizing the pilot symbols that have been multiplied together with the weight factors.

11. The method of claim 10, wherein, if the receiving end apparatus is a Mobile Station (MS), the speed of travel of the receiving end apparatus is estimated using a preamble signal received from a Base Station (BS).

12. The method of claim 10, wherein, if the receiving end apparatus is a Base Station (BS), the speed of travel of the transmitting end apparatus, a Mobile station (MS), is estimated using Channel Quality Information (CQI) received over a CQI feedback channel from the Mobile Station (MS).

13. The method of claim 10, wherein the time correlation value is calculated using an equation:
$$ρ ( {τ}_{p} ) = {J}_{0} ( 2 π {f}_{c} \frac{v}{c} {τ}_{p} )$$
where,
ρ(•): time correlation value operator,
J₀(•): 0^{th} order Bessel function of first kind,
f_{c}: Doppler frequency depending on speed,
ν: speed, and
τₚ: time interval seeking time correlation value.

14. The method of claim 10, wherein the calculating of the weight factors comprises:
calculating a covariance matrix of a received signal and a cross correlation vector between the received signal and a channel factor; and
multiplying an inverse matrix of the covariance matrix together with the cross correlation vector.

15. The method of claim 14, wherein the covariance matrix is calculated using equations:
$${R}_{yy} = [ \begin{matrix}{R}_{k - P , k - P} & ⋯ & {R}_{k - P , k} & ⋯ & {R}_{k - P , K + P} \\ ⋮ & ⋰ & ⋮ & ⋰ & ⋮ \\ {R}_{k , k - P} & ⋯ & {R}_{k , k} & ⋯ & {R}_{k , k + P} \\ ⋮ & ⋰ & ⋮ & ⋰ & ⋮ \\ {R}_{k + P , k - P} & ⋯ & {R}_{k + P , k} & ⋯ & {R}_{k + P , k + P}\end{matrix} ]$$
$${R}_{m , n} = ρ ( {τ}_{m - n} ) {\vert h \vert}^{2} + {σ}^{2}$$
where,
R_{yy}: covariance matrix of received signal,
R_{m,n}: element corresponding to ‘m’ row and ‘n’ column of R_{yy},
ρ(•): time correlation value operator,
τₘ₋ₙ: time interval seeking time correlation value,
h: channel matrix, and
σ²: variance of noise.

16. The method of claim 14, wherein the cross correlation vector is calculated using equations:
P_{yh}[P_{k-P,k} . . . P_{k,k} . . . P_{k+P,k}]^{T}
P_{m,k}=ρ(τₘ₋ₖ)|h|²
where,
P_{yh}: cross correlation vector between received signal and channel factor,
P_{m,k}: element corresponding to ‘k’ row and ‘m’ column of P_{yh},
ρ(•): time correlation value operator,
τₘ₋ₖ: time interval seeking time correlation value, and
h: channel matrix.

17. The method of claim 10, further comprising:
restoring at least one signal of at least one subcarrier from a received Orthogonal Frequency Division Multiplexing (OFDM) symbol, through Fast Fourier Transform (FFT) operation.

18. The method of claim 10, further comprising:
correcting a distortion of a data symbol using the channel estimation value.
